(19) United States
(12) Patent Application Publication
(10) Pub. No.: US 2025/0350833 A1
(43) Pub. Date: Nov. 13, 2025

(54) FOCUSING METHOD FOR CAMERA DEVICE, CAMERA DEVICE, AND COMPUTER-READABLE STORAGE MEDIUM

(71) Applicant: Shenzhen Reolink Technology Co., Ltd., Shenzhen (CN)

(72) Inventors: Qingjie Chen, Shenzhen (CN); Yanchong Chai, Shenzhen (CN); Xuezheng Yang, Shenzhen (CN); Deqiu Mei, Shenzhen (CN); Yusi Chen, Shenzhen (CN)

(21) Appl. No.: 19/277,729

(22) Filed: Jul. 23, 2025

(30) Foreign Application Priority Data
Jul. 24, 2024 (CN) 202411005738.7

(51) Int. Cl. H04N 23/67; H04N 23/661

(52) U.S. Cl. CPC H04N 23/675; H04N 23/661

(57) ABSTRACT

This application relates to a focusing method for a camera device, and a non-transitory computer-readable storage medium. The focusing method includes: acquiring a photographing information label from photographing information of the camera device; determining whether there is a lens position corresponding to the photographing information label in a first database; if there is the lens position corresponding to the photographing information label in the first database; acquiring the lens position corresponding to the photographing information label from the first database according to the photographing information label; generating a focusing control instruction according to the lens position; and controlling a photographing lens of the camera device to be provided at the lens position corresponding to the photographing information label according to the focusing control instruction. The rapid focusing of the camera device is achieved by implementing the focusing method.

### TECHNICAL FIELD

This application relates to the technical field of video monitoring, and more particularly relates to a focusing method for a camera device, a camera device, and a non-transitory computer-readable storage medium.

### BACKGROUND

During a photographing process of a monitoring camera, a distance between the camera and a subject varies frequently, and in order to keep an image photographed by the monitoring camera clear, a focal length and a focus position of a lens need to be constantly changed. This process of adjusting the focal length and the focus position is called focusing, and the focusing is generally divided into manual focusing and automatic focusing. The manual focusing is focusing through a human eye, and during the photographing process of the monitoring camera, manual focus tuning is performed while observing a picture in a viewfinder through the human eye, and when it is judged that the picture in the viewfinder is clear through the eye, the focusing is completed. The automatic focusing is a technology which combines a sensor with the lens, and when a distance between a monitoring target and the lens varies, an automatic focusing system determines definition of the image by analyzing the image captured by an image sensor. Once it is detected that the definition of the image decreases, an automatic focus tuning system drives a motor to adjust a position of a lens group inside the lens to change the focal length and the focus position of the lens.

In order to enable the monitoring camera to be more convenient to use, the automatic focusing system is generally integrated on the monitoring camera. When it is detected that the definition of the image decreases, a position of the lens is firstly adjusted in an adjustable area of the lens with a relatively large moving step length, the definition of the images acquired by the lenses at different positions is compared, then a lens adjustment area in the next round is determined according to a comparison result, the moving step length is appropriately reduced, then the above process is repeated until the moving step length of the lens is reduced to a certain threshold value, and then it is considered that the optimal focusing position is found, namely, the focusing of the monitoring camera is completed. In addition, in the existing automatic focusing system, when the area photographed by the monitoring camera changes, the automatic focusing system performs automatic focusing, and even for the area photographed by the monitoring camera frequently, the position of the lens also needs to be constantly adjusted to find the optimal focusing position.

The above focusing manner in the monitoring camera causes a focusing speed of the monitoring camera to be low, and during a focusing process, a backlash phenomenon of a photographing lens tends to occur, thereby resulting in low focusing efficiency, and also being likely to cause damage to the motor for controlling the photographing lens.

### SUMMARY

This application provides a focusing method for a camera device, a camera device, and a non-transitory computer-readable storage medium, which are directed to solve the problems of a low focusing speed and backlash of a photographing lens of the camera device.

A first aspect of the present application, a focusing method for a camera device is provided. The method includes: acquiring a photographing information label from photographing information of the camera device; determining whether there is a lens position corresponding to the photographing information label in a first database; in response that there is the lens position corresponding to the photographing information label in the first database, acquiring the lens position corresponding to the photographing information label from the first database according to the photographing information label; generating a focusing control instruction of the camera device according to the lens position; and controlling a photographing lens of the camera device to be provided at the lens position corresponding to the photographing information label according to the focusing control instruction.

Optionally, the method further includes: acquiring input marker information, the marker information being used for marking a lens position corresponding to a photographing area; acquiring a current lens position of the camera device; and taking the marker information as the photographing information label, and associating the photographing information label with the current lens position to be stored in the first database.

Optionally, the method further includes: determining whether a current time of the camera device satisfies a photographing triggering time, the photographing triggering time being set in the marker information; and when the current time of the camera device satisfies the photographing triggering time, acquiring the marker information associated with the photographing triggering time, and generating the photographing information according to the marker information.

Optionally, the method further includes: in response that there is no lens position corresponding to the photographing information label in the first database, adjusting the photographing lens step by step according to definition of an image collected by the photographing lens; collecting an image of the photographing area through the photographing lens; acquiring a current lens position of the camera device; and taking the image of the photographing area as the photographing information label, and associating the photographing information label with the current lens position to be stored in the first database.

Optionally, the method further includes: associating the image of the photographing area with the current lens position to be stored in a second database, wherein the second database is configured to store photographing records of the camera device, and the photographing records include the image of the photographing area and the lens position corresponding thereto; analyzing the photographing records in the second database to acquire a photographing frequency corresponding to each of the photographing records; and comparing the photographing frequency corresponding to each of the photographing records with a preset threshold value, and updating the photographing record corresponding to the photographing frequency satisfying the preset threshold value into the first database.

Optionally, the lens position corresponding to the photographing information label is acquired from the first database according to the photographing information label by performing operations includes: calculating similarity between the image of the photographing area corresponding to the photographing information label and each image in the first database; and determining the lens position corresponding to the photographing information label according to the similarity.

Optionally, the method further includes: in response that there is no lens position corresponding to the photographing information label in the first database, adjusting the photographing lens step by step according to definition of an image collected by the photographing lens; acquiring a photographing time of the camera device and a current lens position of the camera device; taking the photographing time as the photographing information label, and associating the photographing information label with the current lens position to be stored in the second database, wherein the second database is used for storing photographing records of the camera device, and the photographing records include the photographing time and the lens position corresponding thereto; analyzing the photographing records in the second database to acquire a photographing frequency corresponding to each of the photographing records; and comparing the photographing frequency corresponding to each of the photographing records with a preset threshold value, and updating the photographing record corresponding to the photographing frequency satisfying the preset threshold value into the first database.

Optionally, the method further includes: determining whether a current time of the camera device satisfies a photographing triggering time, the photographing triggering time being associated with the photographing time; and when the current time of the camera device satisfies the photographing triggering time, acquiring the photographing time associated with the photographing triggering time, and generating the photographing information according to the photographing time.

Optionally, acquiring a photographing information label from photographing information of the camera device, includes: acquiring a plurality of photographing information labels and a photographing priority corresponding to each of the photographing information labels from the photographing information; and comparing the photographing priority corresponding to each of the photographing information labels to acquire the photographing information label corresponding to the highest photographing priority.

A second aspect of the present application provides a camera device. The camera device includes a photographing lens, a memory and a processor, wherein the photographing lens is used for collecting an image; the memory is used for storing a computer program; and the processor executes the computer program to implement the focusing method for a camera device according to any one of the above.

A third aspect of the present application provides a computer-readable storage medium, having a computer program stored therein, wherein the computer program, when executed by a processor, implements the focusing method for a camera device according to any one of the above.

In the present application, the photographing records of the camera device are stored in the first database in advance, and the corresponding lens position is recorded through the photographing information label. In the subsequent photographing process, the camera device may directly acquire the corresponding lens position from the first database according to the photographing information label in the photographing information, and generate the focusing control instruction according to the lens position to adjust the photographing lens. A processor of the camera device can enable the image photographed by the camera device to be clear only by adjusting the lens group in the photographing lens to the corresponding position according to the lens position, without needing to adjust the position of the lens group in the photographing lens repeatedly, so that the focusing speed of the camera device is higher. When the lens group in the photographing lens is adjusted by a focus tuning motor, the focus tuning motor can complete focusing only by rotating to the corresponding position, without needing to rotate back and forth to find the optimal focusing position, so as to effectively avoid the problem of backlash of the focus tuning motor.

The camera device and the non-transitory computer-readable storage medium provided in the present application have the same advantages as the above focusing method for the camera device with respect to the prior art, which will not be described in detail herein.

### BRIEF DESCRIPTION OF THE DRAWINGS

The accompanying drawings are only for purposes of illustrating the embodiments and are not to be construed as limiting the present application. Also, like reference numerals refer to like components throughout the drawings. In the drawings:

FIG. 1 shows a schematic diagram of an application scene of a focusing method for a camera device provided in an embodiment of the present application;

FIG. 2 shows a schematic structural diagram of a camera device provided in an embodiment of the present application;

FIG. 3 shows a schematic flow diagram of the focusing method for a camera device provided in a first embodiment of the present application;

FIG. 4 shows a schematic flow diagram of a generation process of a first database in the focusing method for a camera device provided in an embodiment of the present application;

FIG. 5 shows a first schematic flow diagram of automatically updating the first database in the focusing method for a camera device provided in an embodiment of the present application;

FIG. 6 shows a second schematic flow diagram of automatically updating the first database in the focusing method for a camera device provided in an embodiment of the present application;

FIG. 7 shows a third schematic flow diagram of automatically updating the first database in the focusing method for a camera device provided in an embodiment of the present application;

FIG. 8 shows a schematic flow diagram of the focusing method for a camera device provided in a second embodiment of the present application; and

FIG. 9 shows a schematic flow diagram of the focusing method for a camera device provided in a third embodiment of the present application.

### DETAILED DESCRIPTION

Hereinafter, the illustrative embodiments of the present application will be described in more detail with reference to the accompanying drawings. Although the illustrative embodiments of the present application are shown in the accompanying drawings, it should be understood that the present application may be implemented in various forms and should not be construed as being limited to the embodiments set forth herein.

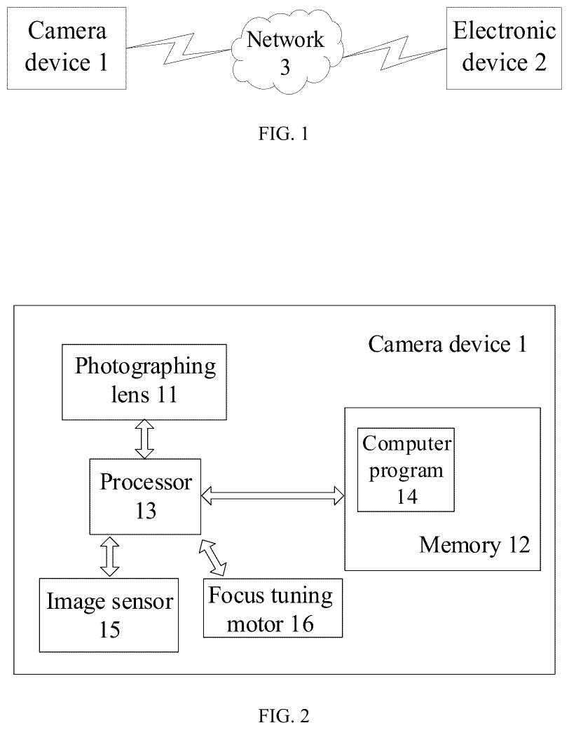

FIG. 1 shows a schematic diagram of an application scene of a focusing method for a camera device provided in an embodiment of the present application. As shown in FIG. 1, the focusing method for a camera device in the embodiment of the present application is applied in the camera device 1. The camera device 1 may be a video camera for security monitoring, an IP camera or other video monitoring devices. The camera device 1 may establish communication connection with an electronic device 2 via a network 3. The electronic device 2 may be a touch-screen phone, a smart phone, a tablet computer, a portable electronic device, or other terminal electronic apparatuses with display screens. The network 3 includes, but is not limited to, one or more of a local area network (LAN), a metropolitan area network (MAN), a wide area network (WAN), a 4G/5G network, WIFI, Bluetooth, and a peer-to-peer (P2P) communication network.

In the embodiment of the present application, the camera device 1 and the electronic device 2 may each include one or more processors, which may be a central processing unit (CPU), or an application specific integrated circuit (ASIC), or one or more integrated circuits configured to implement this embodiment, which is not limited herein. The one or more processors included in the electronic device may be processors of the same type, such as one or more CPUs, and may also be processors of different types, such as one or more CPUs and one or more ASICs, which is not limited herein.

In the embodiment of the present application, the camera device 1 is installed in an area to be monitored (such as home, an office, and a mall), so that the camera device 1 can continuously take monitoring videos in the monitored area and send the taken videos to the electronic device 2 at the terminal via the network 3 for a user to browse.

FIG. 2 shows a schematic structural diagram of a camera device provided in an embodiment of the present application. As shown in FIG. 2, the camera device 1 may include a photographing lens 11, a memory 12 and at least one processor 13, wherein the photographing lens 11 is used for collecting an image, the memory 12 is used for storing a computer program 14, and the at least one processor 13 executes the computer program 14 to implement the focusing method for the camera device.

The photographing lens 11 is configured to photograph and record a photographing area of the camera device 1. A lens group is provided inside the photographing lens 11, the lens group can focus light rays in a scene onto an image sensor 15 of the camera device 1, and then an image is displayed on a display screen of the camera device 1 or a display screen of the electronic device 2. During a focusing process of the camera device 1, the photographing lens 11 is adjusted, and in fact, a position of the lens group inside the photographing lens 11 is adjusted to adjust a distance between the lens group and the image sensor 15 (namely, a focal length). The lens group includes, but is not limited to, one or more of a convex lens, a concave lens, a zoom lens, and an infrared lens.

The processor 13 is coupled to the memory 12 and configured to execute the computer program 14 stored in the memory 12, and may specifically execute the relevant steps in the embodiment of the focusing method for the camera device provided in the present application. Specifically, the computer program 14 may include computerized program instructions.

The processor 13 may be the CPU or the ASIC, or may be one or more integrated circuits configured to implement the embodiment of the present application. The one or more processors included in the camera device 1 may be processors of the same type, such as one or more CPUs, and may also be processors of different types, such as one or more CPUs and one or more ASICs.

The memory 12 is configured to store the computer program 14. The memory 12 may contain a high-speed RAM memory, and may further include a non-volatile memory, such as at least one magnetic disk memory.

In the embodiment of the present application, the camera device 1 further includes a focus tuning motor 16. The processor 13 acquires a lens position from a first database by executing the steps in the embodiment of the focusing method for the camera device described below, and then generates a corresponding focusing control instruction according to the lens position and a current position of the focus tuning motor 16, so as to control the focus tuning motor 16 to drive the photographing lens 11 to move to adjust the photographing lens 11 to complete focusing of the camera device. The focus tuning motor 16 may include a zoom motor and a focusing motor, wherein the zoom motor is used for adjusting the focal length, and the focusing motor is used for adjusting a focus position.

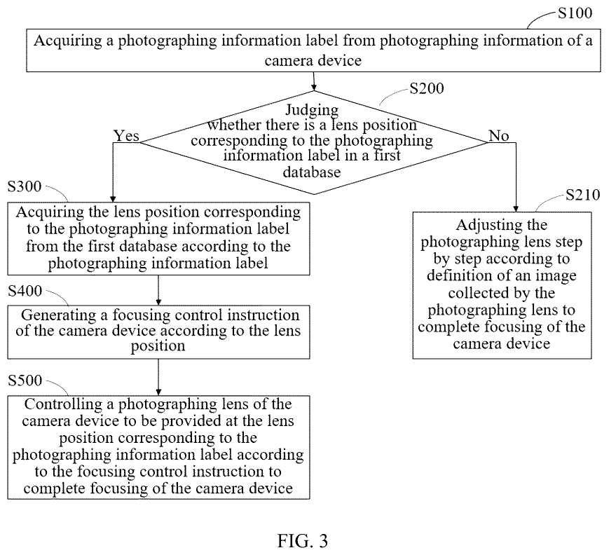

FIG. 3 shows a schematic flow diagram of a focusing method for a camera device provided in a first embodiment of the present application, and the focusing method is applied in the camera device 1. In the embodiment of the present application, the focusing method may be executed by a controller (such as a processor 13) in the camera device 1. As shown in FIG. 3, the method focusing includes the following steps.

Step S100: acquiring a photographing information label from photographing information of the camera device.

In the embodiment, the photographing information is used for characterizing a focusing adjustment requirement of the camera device 1. That is, the controller of the camera device 1 may adjust the focal length and the focus of the camera device 1 according to the photographing information. The photographing information may be automatically generated by the controller of the camera device 1, for example, when the controller of the camera device 1 detects that a current image collected by the photographing lens 11 is blurred, the photographing information is generated according to the image of the photographing area; or when a time on the camera device 1 satisfies a photographing triggering time, and the photographing lens 11 needs to be adjusted to photograph other areas, the controller of the camera device 1 may acquire an associated label set by a user according to the photographing triggering time or generate the photographing information according to the time on the camera device 1. The photographing information may also be a photographing requirement sent by the user, for example, after the user sets a corresponding label for an area to be photographed frequently, when the photographing lens 11 needs to be called to photograph the area, the corresponding label may be clicked on the display screen of the camera device 1 or the electronic device 2, so that the photographing information is generated according to the label to the controller of the camera device 1.

In order to solve the problems of backlash of a focusing motor, low focusing efficiency, and the like, the photographing information label is set, and the photographing information label is used for marking the lens position corresponding to a specific photographing area, so that the controller of the camera device 1 may directly determine the lens position through the photographing information label. The photographing information label may be label information preset by the user, for embodiment, the set label for the area photographed frequently after the user photographs a certain photographing area; and the photographing information label may also be information automatically acquired by the camera device 1, for embodiment, the image of the photographing area, the time on the camera device 1, and the like.

Step S200: determining whether there is a lens position corresponding to the photographing information label in a first database.

If there is a lens position corresponding to the photographing information label in the first database, it is indicated that there is a photographed lens position in the first database, which may be directly called, and step S300 is executed.

If there is no lens position corresponding to the photographing information label in the first database, it is indicated that there is no photographed lens position in the first database, and adjustment of the lens position needs to be performed again, and step S210 is executed.

Step S300: acquiring the lens position corresponding to the photographing information label from the first database according to the photographing information label.

In the embodiment, the first database is configured to store the photographing information label and the lens positions corresponding thereto, and data in the first database may be saved by the user. For example, after the camera device 1 is installed, the user sets the corresponding label for the area photographed frequently according to own usage habits, and the controller of the camera device 1 associates the set label with the lens position of the camera device 1 to be stored in the first database. In the embodiment of the present application, as an instance, a saving button may be set in a display interface of the electronic device 2, and the user may associate the lens position of the camera device 1 with the set label by clicking the saving button to be stored in the first database. When the photographing area of the camera device 1 needs to be adjusted, a button corresponding to the set label may be clicked, so that the electronic device 2 takes the set label as the photographing information label, and sends the photographing information to the controller of the camera device 1.

The data in the first database may also be automatically saved by the controller of the camera device 1. Specifically, when the camera device 1 photographs a new area, after the camera device 1 completes focusing by using an automatic focusing adjustment method, such as an exhaustive search method, a hill climbing search method and a neural network model, an image of the area is associated with a lens position after the camera device 1 completes focusing to be stored in the first database, and when the camera device 1 photographs the area again next time, the image of the area may be taken as the photographing information label, and the corresponding lens position may be directly acquired from the first database without needing to use the automatic focusing adjustment method to perform focusing adjustment again. The controller of the camera device 1 may also save a photographing record of the camera device, the time when the controller of the camera device 1 adjusts the position of the photographing lens 11 is associated with the lens position after focusing adjustment to be stored as the photographing record, and the habit of using the camera device 1 of the user is obtained by analyzing the photographing record. When the controller of the camera device 1 detects that the user frequently performs the same adjustment to the photographing lens 11 at a certain time, the time and the corresponding lens position may be stored in the first database, and when the time arrives again, the controller of the camera device 1 may automatically take the time as the photographing information label, and automatically acquire the lens position to adjust the photographing lens 11.

The first database may be stored in a storage medium on the camera device 1, and the storage medium may be the memory 12, a hard disk and the like which are provided inside the camera device 1 and may also be an external storage medium connected with the camera device 1, such as a U disk, the hard disk, and an optical disk; and the first database may also be stored in a server device which may store data and is connected with the camera device 1 via the network 3. The server device may be a cloud server for storing data.

When there are a plurality of types of photographing information labels, corresponding markers may be set for the photographing information labels, and corresponding markers are set for different types of data in the first database, so that when the controller of the camera device 1 acquires the lens position, the corresponding data may be searched according to the markers corresponding to the photographing information labels, without needing to search all the data in the first database. Of course, the data corresponding to different types of photographing information labels in the first database may also be stored in different data tables, and when the controller of the camera device 1 acquires the lens position, only the corresponding data table needs to be searched according to the marker corresponding to the photographing information label.

Step S400: generating a focusing control instruction of the camera device according to the lens position.

In the embodiment, the lens position is used for characterizing a focal length and a focus position of the photographing lens 11 of the camera device 1. Specifically, when a lens group is provided in the photographing lens 11 of the camera device 1, the lens position may be a position of the lens group, namely, a positional relationship between each lens in the lens group and a positional relationship between the lens group and the image sensor 15. In addition, when the position of the lens group is adjusted by the focus tuning motor 16, the lens position may also be a position of the focus tuning motor 16. In the camera device 1, a moving direction of the lens group corresponds to a rotating direction of the focus tuning motor 16, a moving distance of the lens group corresponds to the number of rotation turns of the focus tuning motor 16, and when adjusting the position of the lens group, the camera device 1 actually controls the focus tuning motor 16 to rotate for the corresponding number of rotation turns in a certain direction.

The controller of the camera device 1 may directly take the lens position as the focusing control instruction. For example, when the lens group in the photographing lens 11 may be self-adjusted according to the instruction sent by the controller, the controller of the camera device 1 may directly take the lens position as the focus control instruction; and when the lens group in the photographing lens 11 is controlled by the focus tuning motor 16, and the lens position is the position of the focus tuning motor 16, the controller of the camera device 1 may directly take the lens position as the focusing control instruction.

The controller of the camera device 1 may also acquire a current lens position of the camera device 1, then determine the focusing adjustment direction and distance of the photographing lens 11 in combination with the lens position, and finally generate the focusing control instruction according to the focusing adjustment direction and distance. For example, when the lens group in the photographing lens 11 may be self-adjusted according to the instruction sent by the controller, the controller of the camera device 1 may acquire the current position of the lens group, then determine the moving direction and the moving distance of the lens group in combination with the lens position, and finally generate the focusing control instruction according to the moving direction and the moving distance; and when the lens group in the photographing lens 11 is controlled by the focus tuning motor 16, if the lens position is the position of the lens group, the controller of the camera device 1 may acquire the current position of the lens group, then determine the moving direction and the moving distance of the lens group in combination with the lens position, afterwards determine the rotating direction and the number of rotation turns of the focus tuning motor 16 according to the moving direction and the moving distance, and finally generate the focusing control instruction according to the rotating direction and the number of rotation turns; and if the lens position is the position of the focus tuning motor 16, the controller of the camera device 1 may acquire the current position of the focus tuning motor 16, then determine the rotating direction and the number of rotation turns of the focus tuning motor 16 in combination with the lens position, and finally generate the focusing control instruction according to the rotating direction and the number of rotation turns.

In addition, when the camera device 1 adjusts the photographing lens 11, the focus tuning motor 16 is generally controlled directly for adjustment. When the lens position is the position of the focus tuning motor 16, the controller of the camera device 1 may directly generate the focusing control instruction according to the position of the focus tuning motor 16 to control the focus tuning motor 16, without needing to infer the position of the focus tuning motor 16 according to the lens position, and then generate the focusing control instruction according to the position of the focus tuning motor 16, so that the controller of the camera device 1 generates the focusing control instruction at a higher speed, and a focusing speed of the camera device 1 may be improved.

Step S500: controlling a photographing lens 11 of the camera device 1 to be provided at the lens position corresponding to the photographing information label according to the focusing control instruction to complete focusing of the camera device.

In the embodiment, when the controller of the camera device 1 directly takes the lens position as the focusing control instruction, a component for adjusting the photographing lens 11 on the camera device 1 may determine the focusing adjustment direction and distance of the photographing lens 11 in combination with the current lens position of the camera device 1, and then control the photographing lens 11 of the camera device 1 to move for a corresponding distance according to the focusing adjustment direction to complete the focusing of the camera device 1. Taking the camera device 1 adjusting the photographing lens 11 through the focus tuning motor 16 as an embodiment, when receiving the focusing control instruction, the focus tuning motor 16 also needs to determine the rotating direction and the number of rotation turns in combination with the current position thereof, and finally completes the focusing of the camera device 1 by rotating for the corresponding number of rotation turns according to the rotating direction.

When the controller of the camera device 1 generates the focusing instruction according to the focusing adjustment direction and distance, the component for adjusting the photographing lens 11 on the camera device 1 may directly adjust the corresponding distance according to the focusing adjustment direction to complete the focusing of the camera device 1. Taking the camera device 1 adjusting the photographing lens 11 through the focus tuning motor 16 as an example, when receiving the focusing control instruction, the focus tuning motor 16 may directly determine the rotating direction and the number of rotation turns according to the focusing control instruction, and finally rotate for the corresponding number of rotation turns directly according to the rotating direction to complete the focusing of the camera device 1.

In summary, in the example of the present application, by storing the photographing records in the first database in advance, and by recording the corresponding lens position through the photographing information label, in the subsequent photographing process, the camera device 1 may directly acquire the corresponding lens position from the first database according to the photographing information label in the photographing information, and generate the focusing control instruction according to the lens position to adjust the photographing lens 11. A controller of the camera device 1 can enable the picture photographed by the camera device 1 to be clear only by adjusting the lens group in the photographing lens 11 to the corresponding position according to the lens position, without needing to adjust the position of the lens group in the photographing lens 11 repeatedly, so that the focusing speed of the camera device 1 is higher. When the lens group in the photographing lens 11 is adjusted by a focus tuning motor 16, the focus tuning motor 16 can complete focusing only by rotating to the corresponding position, without needing to rotate back and forth to find the optimal focusing position, so as to effectively avoid the problem of backlash of the focus tuning motor 16.

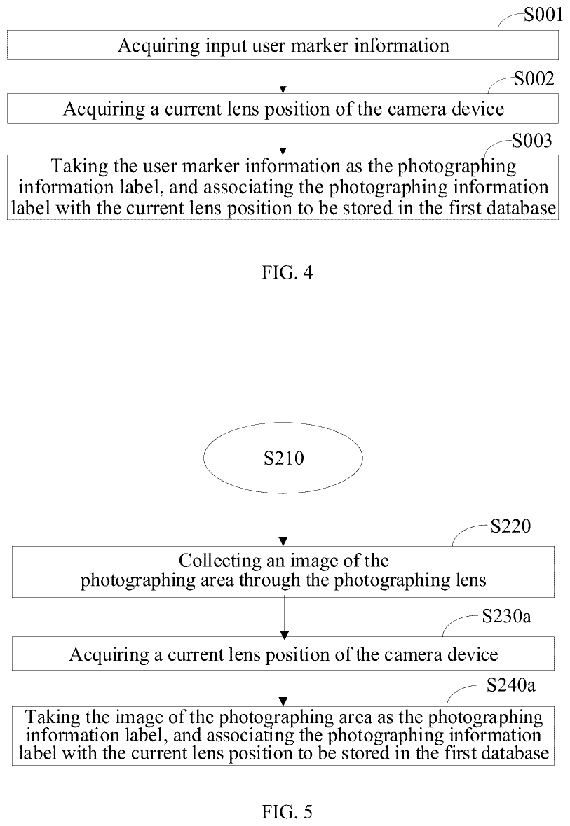

In order to be able to quickly acquire the lens position through the photographing information label, the photographing information label and the lens position corresponding to the photographing information label need to be set in the first database in advance. As shown in FIG. 4, which shows a schematic flow diagram of a generation process of a first database in the focusing method for a camera device provided in an embodiment of the present application, and the generation process of the first database includes the following steps.

Step S001: acquiring input marker information, the marker information being used for marking a lens position corresponding to a photographing area.

After the user uses the camera device 1 for photographing a certain photographing area, completes focusing, and completes photographing, the user may mark the lens position corresponding to the photographing area through the display screen of the camera device 1 to be directly used subsequently.

When the camera device 1 is provided with the display screen, and the camera device 1 can be controlled through the display screen, the marker information may be operated on the display screen of the camera device 1 and then sent to the controller of the camera device 1, and may also be operated on the electronic device 2 establishing connection with the camera device 1 and then sent to the controller of the camera device 1 by the electronic device 2 via the network 3. The marker information may be any label set by the user, for example, the label indicating a place, such as “doorway” and “road”; the label indicating time, such as “morning” and “noon”; or other labels composed of any letter, number and text.

Step S002: acquiring a current lens position of the camera device 1.

When the user needs to record the lens position corresponding to the current photographing area after the photographing is completed, the marker information may be input through the display screen, and the lens position corresponding to the marker information is the lens position of the camera device 1 at the current time. The current lens position acquired by the controller of the camera device 1 may further include the position of the entire photographing lens 11 in addition to being used for characterizing the focal length and the focus position of the photographing lens 11, so that the controller of the camera device 1 may adjust a photographing position of the photographing lens 11 according to the lens position to photograph a specific area.

Step S003: taking the marker information as the photographing information label, and associating the photographing information label with the current lens position to be stored in the first database.

After the user sets and saves the marker information, the current lens position corresponding to the marker information will be recorded in the first database, so that the camera device 1 directly calls the lens position corresponding to the marker information in the subsequent photographing process to adjust the photographing lens 11 to photograph the specific area.

In the embodiment, as an instance, it is assumed that the user needs to frequently call the camera device 1 to photograph the area corresponding to the “doorway”, after the user completes the photographing of the “doorway” area by means of manual focus tuning, and the like. The user may choose to manually add the marker information by setting options, for example, “doorway”: when the user clicks saving, the system will automatically associate the marker information “doorway” with the lens position at the current time to be stored in the first database. In the subsequent use, when the user directly clicks the “doorway” by means of setting, the controller of the camera device 1 will acquire the photographing information with the photographing information label of “doorway”, then acquire the lens position corresponding to the “doorway” from the first database, and finally adjust the area photographed by the photographing lens 11 so that the photographing lens 11 photographs the area corresponding to the “doorway”, and adjust the focal length and the focus position of the photographing lens 11 so that the camera device 1 may acquire a clear image of the “doorway” area.

In the embodiment, the user saves the lens position corresponding to the area which needs to be frequently photographed by using the camera device 1 according to own habits, and associates the input marker information with the lens position to be stored in the first database. When the camera device 1 needs to be used for photographing a certain area, only the marker information corresponding to the area needs to be provided to the controller of the camera device 1, and the controller of the camera device 1 can automatically adjust the photographing lens 11 according to the lens position, so that the camera device 1 is more convenient to use.

It should be noted that the order of execution between the generation process of the first database in steps S001-S003 and step S100 does not necessarily have a precedence order. The generation process of the first database can occur before step S100, namely, before photographing, firstly the user actively saves the lens positions corresponding to some areas which need to be photographed frequently by using the camera device 1; and the setting may also be performed after certain photographing is completed, namely, the photographing process and the generation process of the first database are independent from each other, and only when the photographing information label and the lens position are saved in the first database, the backlash of the lens can be effectively reduced, and the focusing efficiency can be improved.

In order to enable the camera device 1 to be more convenient to use, in steps S001 to S003, when the user sets the marker information, new attribute information may also be set for the marker information. For example, the photographing triggering time is set in the marker information. When the photographing triggering time is set by the user, the camera device will trigger the relevant operation when the system time satisfies the photographing triggering time. Further, the focusing method for the camera device further includes:
step S004a: determining whether a current time of the camera device 1 satisfies a photographing triggering time, the photographing triggering time being set in the marker information in an associated manner;
step S005a: when the current time of the camera device 1 satisfies the photographing triggering time, acquiring the marker information associated with the photographing triggering time, and generating the photographing information according to the marker information.

wherein the photographing triggering time plays a role of timing, namely, when the user sets the marker information, a time may also be set for the marker information. As an instance, it is assumed that the user needs to photograph the “doorway” at 7:00 a.m. every day, the user may also mark a time for the marker information (namely, 7:00 a.m.) after setting the “doorway” as the marker information. During the running process of the camera device 1, the controller of the camera device 1 acquires the time on the camera device 1. When the time on the camera device 1 satisfies “7:00 a.m.”, the marker information (namely, the doorway) corresponding to “7:00 a.m.” is acquired, and the photographing information is generated according to the marker information, so that the controller of the camera device 1 adjusts the photographing lens 11 according to the photographing information.

Of course, the photographing triggering time may be, in addition to a specific time, a time range indicating that the camera device 1 needs to photograph the photographing area characterized by the marker information within the time range. In the embodiment of the present application, as an instance, it is assumed that the photographing triggering time corresponding to the “doorway” is “7:00 a.m. to 8:00 a.m.”, the controller of the camera device 1 may firstly save the current lens position at the time of “7:00 a.m.”, then adjust the photographing lens 11 according to the lens position corresponding to the “doorway”, and adjust the photographing lens 11 according to the previously saved lens position at the time of “8:00 a.m.” to continue to photograph the photographing area before “7:00 a.m.”.

The current time of the camera device 1 satisfies the requirement of the photographing triggering time, which may specifically be that the current time of the camera device 1 is the same as the photographing triggering time, for example, if the photographing triggering time is “7:00 a.m.”, the camera device 1 will generate the photographing information according to the acquired marker information only when the time on the camera device 1 is “7:00” or “7:00 a.m.”; and if the photographing triggering time is “6:30 p.m.”, the controller of the camera device 1 generates the photographing information according to the acquired marker information only when the time on the camera device 1 is “18:30” or “6:30 p.m.”, and so on. A time range may also be generated according to the photographing triggering time, and when the current time of the camera device 1 is within the time range, the controller of the camera device 1 generates the photographing information according to the acquired marker information, for example, it is assumed that the time of five minutes before and after the photographing triggering time is the time range satisfying the photographing triggering time, if the photographing triggering time is “7:00 a.m.”, the controller of the camera device 1 will generate the photographing information according to the acquired marker information as long as the time on the camera device 1 is “6:55 to 7:05” or “6:55 a.m. to 7:05 a.m.”; and if the photographing triggering time is “6:30 p.m.”, the controller of the camera device 1 will generate the photographing information according to the acquired marker information as long as the time on the camera device 1 is “18:25 to 18:35” or “6:25 p.m. to 6:35 p.m.”, and so on.

In the embodiment of the present application, the user may set a photographing triggering time in the marker information used at the same time according to own usage habits, and associate the marker information with the photographing triggering time, so that the controller of the camera device 1 can automatically adjust the photographing lens 11 to photograph the photographing area corresponding to the marker information at the specific time, without needing that the user clicks a key corresponding to the marker information at the specific time to control the camera device 1 to photograph the specific area, so that the camera device 1 is more convenient to use.

With regard to the camera device 1 which has just completed initialization, generally the first database does not record any photographing information label, and the user also does not set the information in the first database. In this case, as shown in FIG. 5, FIG. 5 shows a first schematic flow diagram of automatically updating the first database in the focusing method for the camera device provided in an embodiment of the present application. During the process of using the camera device 1, the process of automatically updating the first database includes:

step S210: if there is no lens position corresponding to the photographing information label in the first database, adjusting the photographing lens step by step according to definition of an image collected by the photographing lens to complete focusing of the camera device.

In response that there is no lens position corresponding to the photographing information label in the first database, the controller of the camera device 1 cannot directly adjust the photographing lens 11 according to the lens position, and at this time, the photographing lens 11 may be adjusted by using an automatic focusing adjustment method, such as an exhaustive search method and a hill climbing search method. However, these automatic focusing adjustment methods need to adjust the photographing lens 11 repeatedly to find the clearest position, so that the speed is low, and the focus tuning motor 16 for adjusting the photographing lens 11 has the problem of backlash, even if the clearest position is found, the photographing lens 11 may not be returned to the clearest position due to the problem of backlash of the focus tuning motor 16.

Therefore, the definition of the picture photographed by the camera device 1 may also be detected by using a pre-trained neural network model, and when the photographing lens 11 is adjusted, the definition of the picture photographed by the camera device 1 is detected by adopting the neural network model in real time. When a detection result of the neural network model meets the requirement, namely, when the detection result of the neural network model is that the image is clear, or the definition detected by the neural network model is greater than or equal to a preset definition threshold value, the adjustment to the photographing lens 11 is stopped, so as to complete the focusing of the camera device 1. A neural network is a technology which simulates the neural network of human brain to achieve artificial intelligence-like machine learning, and by training the neural network model, the accuracy of the detection result of the neural network model on the definition of the picture photographed by the camera device 1 may be improved, so that when the camera device 1 adjusts the photographing lens 11, the clearest position of the picture may be found, and the problem of backlash of the focus tuning motor 16 can also be avoided.

Step S220: collecting an image of the photographing area through the photographing lens 11;

step S230a: acquiring a current lens position of the camera device;

step S240a: taking the image of the photographing area as the photographing information label, and associating the photographing information label with the current lens position to be stored in the first database.

When the camera device 1 is a monitoring camera device, the photographing area thereof is relatively fixed, namely, the monitoring camera device may photograph the same area for a long time during use, and the photographing area may be changed only occasionally. Therefore, when the photographing area of the camera device 1 is changed, the image of the photographing area and the corresponding lens position may be directly stored in the first database.

After the focusing of the camera device 1 is completed, the image of the photographing area is automatically saved, wherein the image may be the image corresponding to the photographing area, scene features of the photographing area (such as items included in the image corresponding to the photographing area, and a positional relationship between various items), and the like, and the scene features of the photographing area may be acquired from the image corresponding to the photographing area by a method such as edge detection, contour extraction, image segmentation and angle detection, and may also be acquired from the image corresponding to the photographing area by a deep learning model such as a convolution neural network. In the embodiment, as an instance, when the camera device 1 photographs the area of the “doorway” for the first time, the camera device 1 records the image of the “doorway” and the corresponding lens position, and when the camera device 1 photographs the “doorway” again next time, the corresponding lens position is acquired from the first database according to the image photographed by the photographing lens 11, and the focusing control instruction is generated according to the acquired lens position to adjust the photographing lens 11, without needing to adjust the photographing lens 11 step by step by the automatic focusing method.

In the embodiment, when there is no lens position corresponding to the photographing information label in the first database, the lens position of the camera device 1 after focusing is associated with the image of the photographing area to be stored in the first database, and when the same area is photographed next time, the controller of the camera device 1 can directly acquire the corresponding lens position from the first database, and then the focusing control instruction is generated according to the lens position to adjust the photographing lens 11, so as to achieve the rapid focusing of the camera device 1.

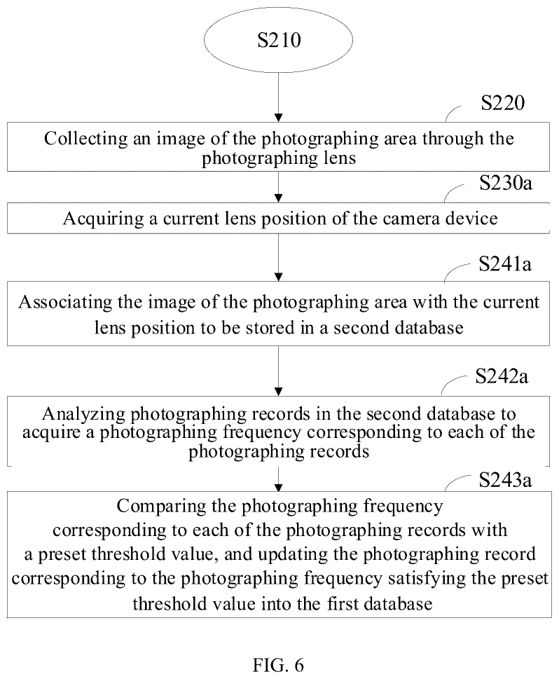

When the camera device 1 adjusts the photographing area frequently, if the lens position corresponding to each photographing area is saved, the amount of data in the first database will be relatively large, which not only requires to occupy a relatively large amount of memory, but also takes more time to acquire the lens position corresponding to the photographing information label from the first database. Therefore, in order to avoid the excessive amount of data in the first database, as shown in FIG. 6, FIG. 6 shows a second schematic flow diagram of automatically updating the first database in the focusing method for the camera device provided in an embodiment of the present application. The process of automatically updating the first database may further include:

step S241a: associating the image of the photographing area with the current lens position to be stored in a second database, wherein the second database is used for storing photographing records of the camera device, and the photographing records include the image of the photographing area and the lens position corresponding thereto.

In this embodiment, the second database is provided, wherein the second database is used for storing the image of the photographing area photographed during the process of using the camera device 1 and the lens position corresponding thereto, and the records of the second database cover all the photographing records within a certain time period (for example, within the last three months and within the last half year), and the data amount is generally relatively large and relatively diversified; and the first database is used for recording the image and the lens position screened from the second database, or set by the user himself.

The second database may be stored in a storage medium of the camera device 1. The storage medium may be the memory 12, a hard disk and the like which are provided inside the camera device 1, and may also be an external storage medium connected with the camera device 1, for example, a U disk, the hard disk, an optical disk, and the like; and the second database may also be stored in a server device which may store data and is connected with the camera device 1 via the network 3, such as a server and a cloud server for storing data. It should be noted that when the second database and the first database are provided in the same storage medium, the second database and the first database may be different data tables provided in the same database, and may also be different database entities, which is not limited in this example;

When the image of the photographing area and the current lens position are stored, the image of the photographing area and the current lens position may be added to the second database as new data, and the data in the second database may also be firstly searched to find out whether there are photographing records which are the same as the image of the photographing area and the current lens position. If there have been photographing records which are the same as the image of the photographing area and the current lens position in the second database, the number of times of recording corresponding to the photographing records is updated. When there is no photographing record which is the same as the image of the photographing area and the current lens position in the second database, the image of the photographing area and the current lens position are added to the second database as new data. Of course, after the photographing lens 11 is adjusted by acquiring the lens position from the first database and generating the focusing control instruction according to the lens position, the image of the photographing area and the lens position may also be stored in the second database as the photographing records.

In addition, when it is found out whether there are photographing records which are the same as the image of the photographing area and the current lens position in the second database, similarity between the image corresponding to the lens position which is the same as the current lens position in the second database and the image of the photographing area may be calculated, and when the similarity between the image of the photographing area and the image in the second database is relatively high, the two are taken as the same data.

Step S242a: analyzing the photographing records in the second database to acquire a photographing frequency corresponding to each of the photographing records; and

step S243a: comparing the photographing frequency corresponding to each of the photographing records with a preset threshold value, and updating the photographing record corresponding to the photographing frequency satisfying the preset threshold value into the first database.

When the photographing records are analyzed, the number of times of recording of the image of the photographing area and the current lens position in the second database may be counted, and when the number of times of recording of the image of the photographing area and the current lens position in the second database is greater than or equal to the preset threshold value, the image of the photographing area and the current lens position are updated into the first database.

Statistical analysis may be performed on the number of times of recording of all the photographing records in the second database to obtain the frequency corresponding to each of the photographing records, and photographing records with frequencies higher than the preset threshold value in all the photographing records are updated into the first database, for example, photographing records with frequencies higher than the preset threshold value such as 60% or 70% are updated into the first database, or photographing records with higher frequencies in all the photographing records are updated into the first database, for example, all the photographing records are ranked according to the corresponding frequencies from high to low, and the photographing records ranking in the first two, the first three, or the first five photographing records are all updated into the first database.

When the photographing record is updated into the first database, the photographing record may be stored in the first database as new data, or it may be firstly found out whether there is data in which the image is the same as the image in the photographing record in the first database, and if so, the lens position corresponding to the image in the first database is updated. When the photographing records are the data with higher frequency in the second database, these photographing records may cover the photographing records updated into the first database last time, so as to achieve the updating of the first database.

In the embodiment of the present application, the image of the photographing area and the corresponding lens position are stored in the second database, and the photographing records in the second database are analyzed. The habit of using the camera device 1 of the user is acquired from the analysis result to determine which areas are photographed more frequently by the camera device 1, and the images and the lens positions corresponding to these areas are updated into the first database, so that the camera device 1 may directly acquire the corresponding lens positions from the first database when photographing these areas, thereby achieving the rapid focusing of the camera device 1. The images and the lens positions of the areas photographed less frequently by the camera device 1 are not stored in the first database, so as to effectively avoid the excessive amount of data in the first database, improve the efficiency of data search, and improve the focusing speed.

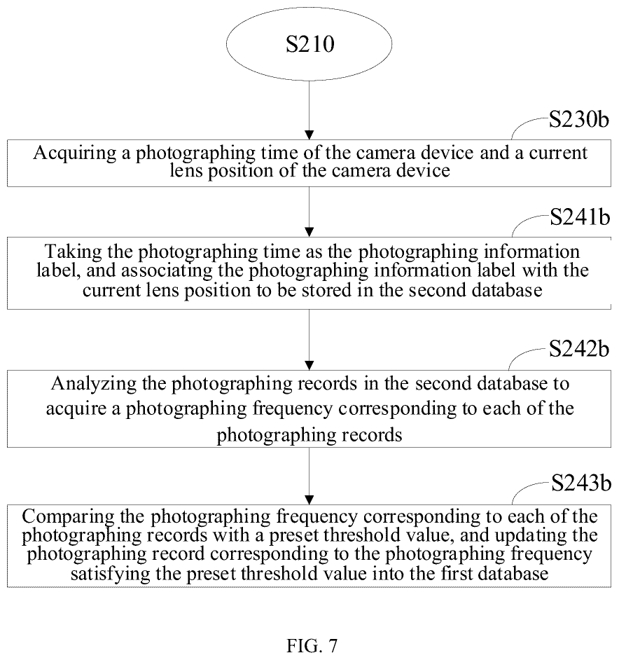

Further, in some instances of the present application, as shown in FIG. 7, FIG. 7 shows a third schematic flow diagram of automatically updating the first database in the focusing method for the camera device provided in an embodiment of the present application. Further, the process of automatically updating the first database may further include:

step S210: if there is no lens position corresponding to the photographing information label in the first database, adjusting the photographing lens 11 step by step according to definition of an image collected by the photographing lens 11 to complete focusing of the camera device 1; and

step S230b: acquiring a photographing time of the camera device 1 and a current lens position of the camera device 1.

The habit of using the camera device 1 of the user may also be related to the photographing time of the camera device 1 in addition to being related to the area photographed frequently by the camera device 1, for example, when the camera device 1 is used for patrol monitoring, the controller of the camera device 1 adjusts the photographing lens 11 according to time to adjust the photographing area of the camera device 1, and at this time, regardless of whether the images of the photographing areas are the same, the controller of the camera device 1 performs the same adjustment to the photographing lens 11 as long as the time is the same. In addition, when the user frequently adjusts the camera device 1 to photograph a certain area at the same time point, the photographing time of the camera device 1 may also be associated with the lens position, and when the controller of the camera device 1 acquires the lens position from the first database, the lens position may be acquired by comparing whether the photographing times are the same, without needing to calculate the similarity between the images and then acquire the lens position according to the similarity, so that the controller of the camera device 1 acquires the lens position at a higher speed.

Step S241b: taking the photographing time as the photographing information label, and associating the photographing information label with the current lens position to be stored in the second database. The second database is used for storing photographing records of the camera device 1, and the photographing records include the photographing time and the lens position corresponding thereto.

In the process of using the camera device 1, there is no necessary connection between the lens position and the photographing time of the camera device 1, for example, the randomness of the user adjusting the camera device 1 to photograph a certain area is relatively high, and taking the user adjusting the camera device 1 to photograph the “doorway” as an example, the user may adjust the camera device 1 in the “morning”, may also adjust the camera device 1 in the “evening”, and may even adjust the camera device 1 several times without regularity in the time of a day. If the photographing time and the lens position are associated and stored in the first database each time after the camera device 1 is adjusted, not only the amount of data in the first database will be relatively large, but also these data will also affect the normal use of the camera device 1. Therefore, when the data associated with the photographing time and the lens position is stored, the photographing time and the current lens position of the camera device 1 need to be firstly stored in the second database, and the photographing records in the second database are analyzed to determine whether the photographing time and the current lens position need to be stored in the first database.

When the photographing time and the current lens position are stored, the photographing time and the current lens position may be added to the second database as new data, and the data in the second database may also be firstly searched to find out whether there are photographing records which are the same as the photographing time and the current lens position. If there have been photographing records which are the same as the photographing time and the current lens position in the second database, the number of times of recording corresponding to the photographing records is updated; and when there is no photographing record which is the same as the photographing time and the current lens position in the second database, the photographing time and the current lens position are added to the second database as new data. Of course, after acquiring the lens position from the first database and adjusting the photographing lens 11 according to the lens position, the photographing time and the lens position may also be stored in the second database as photographing records.

The photographing time may include a moment, for example, the time on the camera device 1 is a certain hour and a certain minute, may be a 12-hour time, such as “7:00 a.m.” and “6:00 p.m.”, and may also be a time in a 24-hour format, such as “7:00” and “18:00”. The photographing time may further include a date, for example, the time on the camera device is a certain year, a certain month, a certain day, a certain day of the week, and the like.

Step S242b: analyzing the photographing records in the second database to acquire a photographing frequency corresponding to each of the photographing records; and

step S243b: comparing the photographing frequency corresponding to each of the photographing records with a preset threshold value, and updating the photographing record corresponding to the photographing frequency satisfying the preset threshold value into the first database.

When the photographing time only includes the moment, the habit of using the camera device 1 of the user within the time of a day (namely, 24 hours) may be determined by analyzing the photographing time in the photographing record, for example, when only the photographing records of last seven days are recorded in the second database, and the photographing time is a time in the 24-hour format, if “7:00” and the lens position corresponding thereto occur seven times in the second database, it may be determined that the user adjusts the photographing lens 11 of the camera device 1 to the same position at 7:00 every morning, and at this time, “7:00” and the lens position corresponding thereto may be stored in the first database, and so on.

When the photographing time includes not only the moment but also the date, not only the habit of using the camera device 1 of the user in the time of a day may be determined according to the moment, but also the habit of using the camera device 1 of the user in the time of a week and a month may be determined in combination with the date. For example, when semi-annual photographing records are recorded in the second database, and the moment in the photographing time is a moment in the 24-hour format, if the photographing time “7:00 Monday” and the lens position corresponding thereto occur in the second database for the same number of times as the date “Monday” occurs in the semi-annual time, it may be determined that the user adjusts the photographing lens 11 of the camera device 1 to the same position at 7:00 a.m. on Monday each week, and at this time, “7:00 Monday” and the lens position corresponding thereto may be stored in the first database; and if the photographing time “7:00 1st” and the lens position corresponding thereto occur six times in the second database, it represents that the user adjusts the photographing lens 11 of the camera device 1 to the same state at 7:00 a.m. on 1st each month, and at this time, “7:00 1st” and the lens position corresponding thereto may be stored in the first database, and so on.

When the photographing record is updated into the first database, the photographing record may be stored in the first database as new data, or it may be firstly found out whether there is data in which the photographing time is the same as the photographing time in the photographing record in the first database, and if there is data in which the photographing time is the same as the photographing time in the photographing record in the first database, the lens position corresponding to the photographing time in the first database is updated.

In the embodiment of the present application, when there is no lens position corresponding to the photographing information label in the first database, after the photographing lens 11 is adjusted step by step, the adjusted lens position may be associated with the photographing time on the camera device 1 to be recorded in the second database, then the photographing records in the second database are analyzed, the habit of using the camera device 1 of the user is acquired from the analysis result to determine at which photographing time the photographing lens 11 of the camera device 1 is adjusted to the same position frequently, and these photographing times and the corresponding lens positions are stored in the first database. When the user adjusts the camera device 1 at the same photographing time next time, the photographing lens may be directly adjusted according to the lens position, so as to achieve the rapid focusing of the camera device 1.

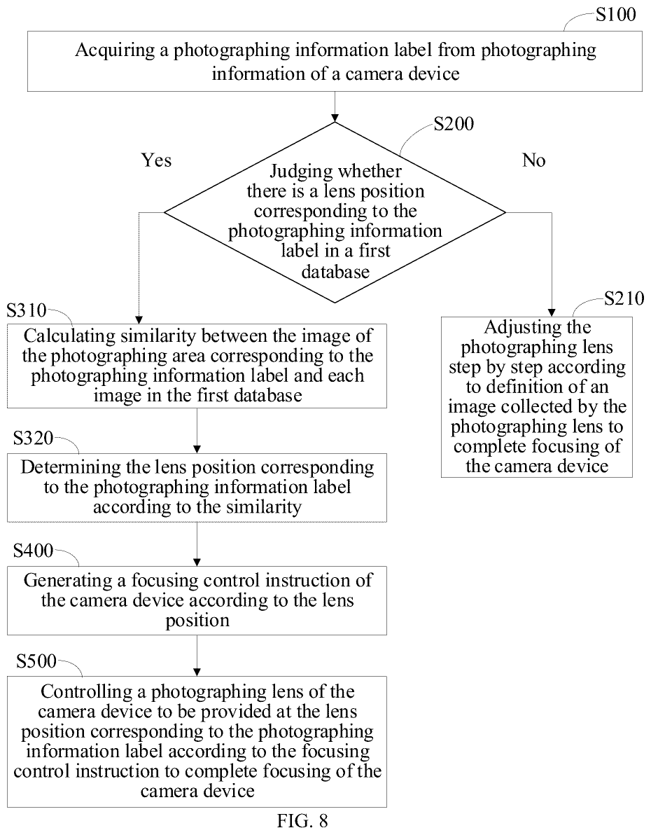

When the image of the photographing area and the corresponding lens position are stored in the first database, during the focusing of the camera device 1, the lens position may be directly called according to the image. As shown in FIG. 8, FIG. 8 shows a schematic flow diagram of the focusing method for the camera device provided in a second embodiment of the present application, wherein merely step S310 to step S320 are used for replacing step S300 in FIG. 3 in the second embodiment, specifically including the following steps:

step S310: calculating similarity between the image of the photographing area corresponding to the photographing information label and each image in the first database; and

step S320: determining the lens position corresponding to the photographing information label according to the similarity.

The images stored in the first database are images acquired after the focusing of the camera device 1 is completed, and these images are generally clear images. However, when the photographing information is acquired, the picture photographed by the camera device 1 is generally blurred, namely, the image of the photographing area corresponding to the photographing information label is generally a blurred image, which results in that the image in the first database is generally not completely the same as the image of the photographing area corresponding to the photographing information label. Therefore, the similarity between the image of the photographing area corresponding to the photographing information label and each image in the first database may be calculated, and then the first database may be searched according to the similarity.

The similarity may be acquired by calculating the image of the photographing area corresponding to the photographing information label and the image in the first database through an algorithm such as semantic feature extraction, a convolution neural network, a graph neural network, and scene graph matching. When the lens position is determined according to the similarity, a preset threshold value may be given, and the lens position corresponding to the image with the similarity greater than the preset threshold value is determined as the lens position corresponding to the photographing information label.

When there are a plurality of images with the similarity greater than the preset threshold value, these images may also be ranked according to the similarity from high to low, and the lens position corresponding to the image with the highest similarity is determined as the lens position corresponding to the photographing information label. For example, when the preset threshold value is 80%, if there are two images with the corresponding similarity both higher than 80% in the first database, the similarity corresponding to one of the images is 85%, and the similarity corresponding to the other image is 90%, the lens position corresponding to the image with the similarity of 90% in the first database is determined as the lens position corresponding to the photographing information label.

In the embodiment, the lens position corresponding to the photographing information label is determined according to the similarity between the image corresponding to the photographing information label and the image in the first database, so that the corresponding lens position may be acquired from the first database rapidly and accurately.

It should be noted that the generation process of the first database provided in steps S210 to S240a, and steps S241a to S243a is independent from the execution process of steps S310 to S320, and there is no necessary dependency relationship. Meanwhile, the user may also set the automatically generated records, and the user may set the number of records in the first database and may also perform operation such as modification or deletion on the records which have been generated. Only when the photographing information label and the lens position are stored in the first database, the backlash of the lens can be effectively reduced, and the focusing efficiency can be improved.

In some embodiments of the present application, the focusing method for the camera device further includes:
step S004b: judging whether a current time of the camera device 1 satisfies a photographing triggering time, the photographing triggering time being associated with the photographing time; and
step S005b: when the current time of the camera device 1 satisfies the photographing triggering time, acquiring the photographing time associated with the photographing triggering time, and generating the photographing information according to the photographing time;
When the data in the first database is that the photographing time is associated with the lens position, the corresponding photographing triggering time may be generated according to the photographing time. When the system time of the camera device 1 meets the requirement of the photographing triggering time, the photographing time corresponding to the photographing triggering time is acquired, and then the lens position is acquired according to the photographing time to adjust the photographing lens 11 of the camera device 1. As an instance, it is assumed that a set of data being “7:00 a.m.” and the lens position corresponding thereto is stored in the first database, the controller of the camera device 1 takes the time of “7:00 a.m.” as the photographing triggering time of this set of data. During the running process of the camera device 1, the controller of the camera device 1 acquires the system time on the camera device 1, and when the system time on the camera device 1 satisfies “7:00 a.m.”, the photographing information is generated according to the photographing time of “7:00 a.m.”.

In the embodiment, the photographing time in the first database is associated with the photographing triggering time, so that the controller of the camera device 1 can automatically perform cyclic photographing for different photographing areas according to the photographing time in the first database.

The above embodiments respectively provide a plurality of focusing modes, when the plurality of focusing modes are integrated onto the camera device 1, the camera device 1 has a plurality of automatic focusing functions, while these functions may collide. For example, when the controller of the camera device 1 receives the photographing information label being the photographing information of the marker information, while the current time on the camera device satisfies the photographing triggering time and the photographing information with the photographing information label being the photographing time is successfully generated, at this time, the controller of the camera device 1 will receive two pieces of photographing information simultaneously, and the photographing information labels included in the two pieces of photographing information are different, which may cause the controller of the camera device to acquire two different lens positions from the first database, thereby causing the controller of the camera device 1 to fail to adjust the photographing lens normally.

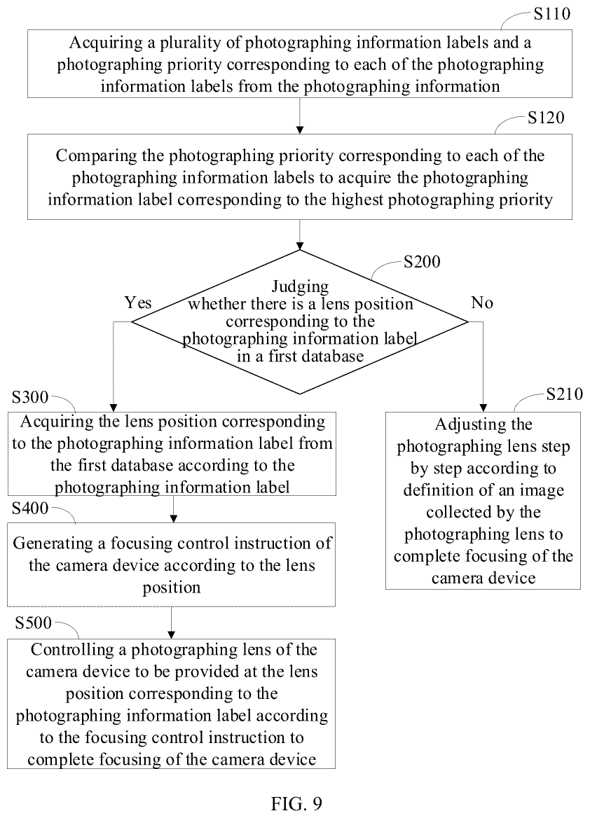

Therefore, in order to further ensure the normal running of the camera device, as shown in FIG. 9, FIG. 9 shows a schematic flow diagram of the focusing method for the camera device provided in a third embodiment of the present application, wherein merely step S110 to step S120 are used for replacing step S100 in FIG. 3 in the third embodiment, specifically including:

step S110: acquiring a plurality of photographing information labels and a photographing priority corresponding to each of the photographing information labels from the photographing information.

The photographing priority may be a corresponding initial priority set for each of the photographing information labels before the camera device 1 leaves the factory. For example, before the camera device 1 leaves the factory, the photographing priorities of the marker information, the image and the photographing time are set as follows: the photographing priority corresponding to the marker information is higher than the photographing priority corresponding to the image, and the photographing priority corresponding to the image is higher than the photographing priority corresponding to the photographing time, wherein the photographing priority corresponding to the marker information acquired through the photographing triggering time is lower than the photographing priority corresponding to the marker information acquired directly, but the photographing priorities corresponding to the marker information acquired in two different modes are both higher than the photographing priorities corresponding to the image and the photographing time.

Of course, the photographing priority may also be set by the user according to own using habit after the camera device 1 is installed, for example, when the user expects that the camera device 1 must photograph a certain area in a certain time period and cannot be affected by any other operation, the photographing priority corresponding to the marker information acquired through the photographing triggering time may be set to be higher than the photographing priorities corresponding to all other photographing information labels, or the photographing priority corresponding to the photographing time may be set to be higher than the photographing priority corresponding to all other photographing information labels; and when the user expects to manually adjust the camera device 1 to photograph a certain area without being affected by any other function, the photographing priority corresponding to the image may be set to be higher than the photographing priority corresponding to all other photographing information labels.

In addition, when functions corresponding to various embodiments are integrated together on the same camera device 1 to enable the camera device 1 to have a plurality of automatic focusing functions, turn-on and turn-off functions may also be set for different automatic focusing functions, and each of the functions is set to be in a default turn-off state, and the required automatic focusing functions may be turned on by the user according to own using habit. For example, when the user does not need the camera device 1 to automatically adjust the photographing lens 11 according to the time thereon, the focusing function for acquiring the photographing time through the photographing triggering time may be turned off, and when the current time of the camera device 1 satisfies the photographing triggering time, the controller of the camera device 1 will not automatically acquire the photographing time to generate the photographing information, and then will not adjust the photographing lens 11 of the camera device 1 according to the lens position corresponding to the photographing time.

Step S120: comparing the photographing priority corresponding to each of the photographing information labels to acquire the photographing information label corresponding to the highest photographing priority;

wherein when the controller of the camera device 1 acquires a plurality of photographing information labels simultaneously, and the types of various photographing information labels are different, the photographing priority corresponding to each of the photographing information labels is compared, and the first database is searched according to the photographing information label with the highest photographing priority. The plurality of photographing information labels acquired simultaneously by the controller of the camera device 1 may come from a plurality of pieces of photographing information respectively, or may all come from the same piece of photographing information, or some of the photographing information labels may come from the same piece of photographing information. In the embodiment of the present application, as an instance, it is assumed that the photographing priority of the marker information is higher than the photographing priority of the image, and the photographing priority of the image is higher than the photographing priority of the photographing time, when the controller of the camera device 1 acquires three photographing information labels simultaneously, and the three photographing information labels are the marker information, the image and the photographing time, respectively, the controller of the camera device 1 will acquire the lens position corresponding to the marker information from the first database according to the marker information with the highest photographing priority.

In addition, steps S200 to S500 in FIG. 9 are the same as steps S200 to S500 in FIG. 3, which will not be described in detail herein.

In the embodiment of the present application, the corresponding photographing priority is set for the photographing information label, and when the controller of the camera device 1 acquires a plurality of photographing information labels simultaneously, the controller of the camera device 1 can search the first database only according to the photographing information label with the highest photographing priority, so as to ensure that the controller of the camera device 1 can only acquire one lens position each time, thereby ensuring the normal use of the camera device 1.

An embodiment of the present application provides a non-transitory computer-readable storage medium having a computer program stored therein, wherein the computer program, when executed by a processor, implements the above embodiment of the focusing method for the camera device 1.

An embodiment of the present application provides a computer program, wherein the computer program may be executed by a processor to implement the above example of the focusing method for the camera device.

An embodiment of the present application provides a computer program product including a computer program, wherein the computer program, when executed by a processor, implements the above example of the focusing method for the camera device.

In several embodiments provided by the present application, any of the functions, if implemented in the form of software functional modules or units and sold or used as a stand-alone product, may be stored in a computer-readable storage medium. Based on such an understanding, all or part of the technical solution of the present application may be embodied in the form of a software product, and the computer software product is stored in a storage medium including several instructions for causing a computer device (which may be an electronic device such as a personal computer and a server) to execute all or part of the steps of the methods as described in various embodiments of the present application, whereas the above storage medium includes: various media which may store computer program codes, such as a U disk, a removable hard disk, a read-only memory (ROM), a random access memory (RAM), a diskette or an optical disk.

The algorithms or displays provided herein are not inherently related to any particular computer, virtual system, or other devices. Various general-purpose systems may also be used with the teachings based on this. The structure required to construct such a system will be apparent according to the above description. In addition, the embodiments of the present application are not directed to any particular programming language. It should be understood that various programming languages may be utilized for implementing the content of the present application as described herein, and that the above description of specific languages is provided to disclose the optimal embodiments of the present application.

It should be noted that the above embodiments illustrate rather than limit the present application, and that those skilled in the art will be able to design alternative embodiments without departing from the scope of the appended claims. In the claims, any reference signs placed between parentheses shall not be construed as limiting the claim. The word “including” does not exclude the presence of elements or steps other than those listed in the claims. The word “a” or “an” preceding an element does not exclude the presence of a plurality of such elements. The present application may be implemented by means of hardware including several different elements, and by means of a suitably programmed computer. In the claims enumerating several apparatuses, several units or modules in these apparatuses may be specifically embodied by the same item of hardware. The use of the words first, second, third, and the like does not denote any order. These words may be interpreted as names. The steps in the embodiments described above, unless otherwise specified, should not be construed as limiting the order of execution.

The embodiments described above express only a few embodiments of the present application and are described in more detail, but should not therefore be construed as limiting the patent scope of the present application. It should be noted that those ordinarily skilled in the art would be able to make several variations and modifications without departing from the concept of the present application, and these are all within the scope of protection of the present application. Therefore, the scope of protection of the present application is as set forth in the appended claims.

What is claimed is:

1. A focusing method for a camera device, comprising:
acquiring a photographing information label from photographing information of the camera device;
determining whether there is a lens position corresponding to the photographing information label in a first database;
in response that there is the lens position corresponding to the photographing information label in the first database, acquiring the lens position corresponding to the photographing information label from the first database according to the photographing information label;
generating a focusing control instruction according to the lens position;
controlling a photographing lens of the camera device to be provided at the lens position corresponding to the photographing information label according to the focusing control instruction.

2. The focusing method according to claim 1, further comprising:
acquiring input marker information, the marker information being used for marking a lens position corresponding to a photographing area;
acquiring a current lens position of the camera device; and
taking the marker information as the photographing information label, and associating the photographing information label with the current lens position to be stored in the first database.

3. The focusing method according to claim 2, further comprising:
determining whether a current time of the camera device satisfies a photographing triggering time, the photographing triggering time being set in the user marker information; and
when the current time of the camera device satisfies the photographing triggering time, acquiring the marker information associated with the photographing triggering time, and generating the photographing information according to the marker information.

4. The focusing method according to claim 1, further comprising:
in response that there is no lens position corresponding to the photographing information label in the first database, adjusting the photographing lens step by step according to definition of an image collected by the photographing lens;
collecting an image of the photographing area through the photographing lens;
acquiring a current lens position of the camera device; and
taking the image of the photographing area as the photographing information label, and associating the photographing information label with the current lens position to be stored in the first database.

5. The focusing method according to claim 4, further comprising:
associating the image of the photographing area with the current lens position to be stored in a second database, wherein the second database is configured to store photographing records of the camera device, and the photographing records comprise the image of the photographing area and the lens position corresponding thereto;
analyzing the photographing records stored in the second database to acquire a photographing frequency corresponding to each of the photographing records; and
comparing the photographing frequency corresponding to each of the photographing records with a preset threshold value, and updating the photographing record corresponding to the photographing frequency satisfying the preset threshold value into the first database.

6. The focusing method according to claim 5, wherein the acquiring the lens position corresponding to the photographing information label from the first database according to the photographing information label, comprises:
calculating similarity between the image of the photographing area corresponding to the photographing information label and each image in the first database; and
determining the lens position corresponding to the photographing information label according to the similarity.

7. The focusing method according to claim 1, further comprising:
in response that there is no lens position corresponding to the photographing information label in the first database, adjusting the photographing lens step by step according to definition of an image collected by the photographing lens;
acquiring a photographing time of the camera device and a current lens position of the camera device;
taking the photographing time as the photographing information label, and associating the photographing information label with the current lens position to be stored in the second database, wherein the second database is used for storing photographing records of the camera device, and the photographing records comprise the photographing time and the lens position corresponding thereto;
analyzing the photographing records in the second database to acquire a photographing frequency corresponding to each of the photographing records; and
comparing the photographing frequency corresponding to each of the photographing records with a preset threshold value, and updating the photographing record corresponding to the photographing frequency satisfying the preset threshold value into the first database.

8. The focusing method according to claim 7, further comprising:
determining whether a current time of the camera device satisfies a photographing triggering time, the photographing triggering time being associated with the photographing time; and
when the current time of the camera device satisfies the photographing triggering time, acquiring the photographing time associated with the photographing triggering time, and generating the photographing information according to the photographing time.

9. The focusing method according to claim 1, wherein the acquiring a photographing information label from photographing information of the camera device, comprises:
acquiring a plurality of photographing information labels and a photographing priority corresponding to each of the photographing information labels from the photographing information; and
comparing the photographing priority corresponding to each of the photographing information labels to acquire the photographing information label corresponding to the highest photographing priority.

10. A camera device, comprising:
a photographing lens configured to collect one or more images;
a memory configured to store one or more computer programs; and
at least one processor coupled to the memory, and configured to execute the one or more computer programs stored in the memory to perform operations comprising:
acquiring a photographing information label from photographing information of the camera device;
determining whether there is a lens position corresponding to the photographing information label in a first database;
in response that there is the lens position corresponding to the photographing information label in the first database, acquiring the lens position corresponding to the photographing information label from the first database according to the photographing information label;
generating a focusing control instruction according to the lens position;
controlling a photographing lens of the camera device to be provided at the lens position corresponding to the photographing information label according to the focusing control instruction.

11. The camera device according to claim 10, wherein the at least one processor executes the computer programs to perform operations comprising:
acquiring input marker information, the marker information being used for marking a lens position corresponding to a photographing area;
acquiring a current lens position of the camera device; and
taking the marker information as the photographing information label, and associating the photographing information label with the current lens position to be stored in the first database.

12. The camera device according to claim 11, wherein the at least one processor executes the computer programs to perform operations comprising:
determining whether a current time of the camera device satisfies a photographing triggering time, the photographing triggering time being set in the user marker information; and
when the current time of the camera device satisfies the photographing triggering time, acquiring the marker information associated with the photographing triggering time, and generating the photographing information according to the marker information.

13. The camera device according to claim 10, wherein the at least one processor executes the computer programs to perform operations comprising:
in response that there is no lens position corresponding to the photographing information label in the first database, adjusting the photographing lens step by step according to definition of an image collected by the photographing lens;
collecting an image of the photographing area through the photographing lens;
acquiring a current lens position of the camera device; and
taking the image of the photographing area as the photographing information label, and associating the photographing information label with the current lens position to be stored in the first database.

14. The camera device according to claim 13, wherein the at least one processor executes the computer programs to perform operations comprising:
associating the image of the photographing area with the current lens position to be stored in a second database, wherein the second database is configured to store photographing records of the camera device, and the photographing records comprise the image of the photographing area and the lens position corresponding thereto;
analyzing the photographing records stored in the second database to acquire a photographing frequency corresponding to each of the photographing records; and
comparing the photographing frequency corresponding to each of the photographing records with a preset threshold value, and updating the photographing record corresponding to the photographing frequency satisfying the preset threshold value into the first database.

15. The camera device according to claim 14, wherein the operation of acquiring the lens position corresponding to the photographing information label from the first database according to the photographing information label, comprises the following operations:
calculating similarity between the image of the photographing area corresponding to the photographing information label and each image in the first database; and
determining the lens position corresponding to the photographing information label according to the similarity.

16. The camera device according to claim 10, wherein the at least one processor executes the computer programs to perform operations comprising:
in response that there is no lens position corresponding to the photographing information label in the first database, adjusting the photographing lens step by step according to definition of an image collected by the photographing lens;
acquiring a photographing time of the camera device and a current lens position of the camera device;
taking the photographing time as the photographing information label, and associating the photographing information label with the current lens position to be stored in the second database, wherein the second database is used for storing photographing records of the camera device, and the photographing records comprise the photographing time and the lens position corresponding thereto;
analyzing the photographing records in the second database to acquire a photographing frequency corresponding to each of the photographing records; and
comparing the photographing frequency corresponding to each of the photographing records with a preset threshold value, and updating the photographing record corresponding to the photographing frequency satisfying the preset threshold value into the first database.

17. The camera device according to claim 16, wherein the at least one processor executes the computer programs to perform operations comprising:
judging whether a current time of the camera device satisfies a photographing triggering time, the photographing triggering time being associated with the photographing time; and
when the current time of the camera device satisfies the photographing triggering time, acquiring the photographing time associated with the photographing triggering time, and generating the photographing information according to the photographing time.

18. The camera device according to claim 10, wherein the operation of acquiring a photographing information label from photographing information of the camera device, comprises:
acquiring a plurality of photographing information labels and a photographing priority corresponding to each of the photographing information labels from the photographing information; and
comparing the photographing priority corresponding to each of the photographing information labels to acquire the photographing information label corresponding to the highest photographing priority.

19. A non-transitory computer-readable storage medium having a plurality of program instructions stored therein, wherein the computerized program instructions, when executed by one or more processors, implements a focusing method for a camera device, the focusing method comprising:
acquiring a photographing information label from photographing information of the camera device;
determining whether there is a lens position corresponding to the photographing information label in a first database;
in response that there is the lens position corresponding to the photographing information label in the first database, acquiring the lens position corresponding to the photographing information label from the first database according to the photographing information label;
generating a focusing control instruction according to the lens position;
controlling a photographing lens of the camera device to be provided at the lens position corresponding to the photographing information label according to the focusing control instruction.

20. The non-transitory computer-readable storage medium according to claim 19, wherein the focusing method further comprises:
in response that there is no lens position corresponding to the photographing information label in the first database, adjusting the photographing lens step by step according to definition of an image collected by the photographing lens;
collecting an image of the photographing area through the photographing lens;
acquiring a current lens position of the camera device; and
taking the image of the photographing area as the photographing information label, and associating the photographing information label with the current lens position to be stored in the first database.
